(19) United States
(12) Patent Application Publication
(10) Pub. No.: US 2015/0150293 A1
(43) Pub. Date: Jun. 4, 2015

(54) METHOD FOR PRODUCING ENOKITAKE MUSHROOM EXTRACT, ENOKITAKE MUSHROOM EXTRACT, AND FOOD ADDITIVE

(71) Applicants: A SCHOOL CORPORATION KANSAI UNIVERSITY, Osaka (JP); ICHIEI CO., LTD., Nagano (JP)

(72) Inventors: Hidehisa Kawahara, Osaka (JP); Yoshihide Koide, Nagano (JP)

(21) Appl. No.: 14/401,776

(22) PCT Filed: May 13, 2013
(86) PCT No.: PCT/JP2013/063296

§ 371 Date: Nov. 17, 2014

(30) Foreign Application Priority Data
May 16, 2012 (JP) 2012-112438

(51) Int. Cl. A23L 1/28

(52) U.S. Cl. CPC A23L 1/28; A23V 2002/00

(57) ABSTRACT

Provided is, for example, a method for producing an enokitake mushroom extract that includes immersing an enokitake mushroom fruiting body in alcohol, subsequently separating the fruiting body from the alcohol, and immersing the separated enokitake mushroom fruiting body in water at 80° C. or higher, subsequently obtaining a supernatant as an extract.

### CROSS REFERENCE TO RELATED APPLICATIONS

This application claims the priority to Japanese Patent Application No. 2012-112438, the entire disclosure of which is incorporated herein by reference.

### FIELD OF THE INVENTION

The present invention relates to a method for producing an enokitake mushroom (Flammulina velutipes) extract, an enokitake mushroom extract and a food additive containing the enokitake mushroom extract.

### RELATED ART

Extracts extracted from fungi such as mushrooms and molds, Lichenes, and the like are known to contain hydrophobin, which is an adhesive and emulsifiable low molecular protein. Application of such hydrophobin to various agents such as thickeners, emulsifiers and surfactants has been studied.

For examples, Patent Literatures 1 to 3 describe the use of hydrophobin derived from fungi as food additives.

Patent Literatures 1 to 3 describe, as the methods for obtaining hydrophobin, a gene recombination technique in which a hydrophobin encoding gene is isolated from a fungus and introduced to a host cell to obtain hydrophobin, and extraction of hydrophobin from a fungal mycelium using ethanol or the like.

However, use of hydrophobin produced by the gene recombination technique for food products as a food additive is sometimes limited from the viewpoint of safety.

Also, a typical extraction method from fungal mycelium using ethanol or the like yields only a small amount of extract, thereby poor in extraction efficiency, hence problematic.

Non Patent Literature 1 describes a hydrophobin extraction method involving treatment with a chemical agent such as sodium dodecyl sulfate (SDS). According to the method, the amount of hydrophobin extracted increases. However, the hydrophobin extracted by such an extraction method is not preferable from the viewpoint of safety.

### CITATION LIST

### Patent Literature

Patent Literature 1: JP2008-507958 A
Patent Literature 2: JP2008-507959 A
Patent Literature 3: JP2011-41583 A

### Non Patent Literature

Non Patent Literature 1: Interfacial Self-Assembly of Fungal Hydrophobins of the Lichen-Forming Ascomycetes Xanthoria parientina and X. ectaneoides, Fungal Genetics and Biology 30, 81-93(2000)

### DISCLOSURE OF THE INVENTION

### Problems to be Solved by the Invention

In consideration of the above circumstances, it is an object of the present invention to provide a method for effectively obtaining a very safe extract containing a relatively large amount of hydrophobin, and an extract and a food additive which are very safe.

### Means for Solving Problems

To solve the above problems, a method for producing an enokitake mushroom extract of the present invention includes:

immersing an enokitake mushroom fruiting body in alcohol, subsequently separating the fruiting body from the alcohol; and

immersing the separated enokitake mushroom fruiting body in water at 80° C. or higher, subsequently obtaining a supernatant as an extract.

According to the present invention, the method may include immersing the enokitake mushroom fruiting body in an acidic solution, before immersion in alcohol, and subsequently separating the fruiting body from the acidic solution.

The acidic solution may have a pH of 1.0 to 3.0.

The acidic solution may be an acetic acid solution.

An enokitake mushroom extract of the present invention is extracted by:

immersing an enokitake mushroom fruiting body in alcohol, subsequently separating the fruiting body from the alcohol; and

immersing the separated enokitake mushroom fruiting body in water at 80° C. or higher.

According to the present invention, there is also provided a food additive that includes the enokitake mushroom extract.

### BRIEF DESCRIPTION OF THE DRAWINGS

FIG. 1 is a graph showing the emulsification activity of the enokitake mushroom extracts of Examples.

FIG. 2 is a graph showing the emulsification activity of the enokitake mushroom extracts of Examples.

FIG. 3 is a GPC chromatograph showing the binding ability of the enokitake mushroom extracts of Examples to hydroxypropyl cellulose.

FIG. 4 is a GPC chromatograph showing the binding ability of the enokitake mushroom extracts of Examples to pectin.

FIG. 5 is a GPC chromatograph showing the binding ability of the enokitake mushroom extracts of Examples to waxy cornstarch.

FIG. 6 is a graph showing the relation of protein concentrations in the enokitake mushroom extracts and the adhesiveness to each of the test samples.

FIG. 7 is a graph showing the height measurement results of bubbles formed by a shampoo.

### DESCRIPTION OF EMBODIMENTS

The method for producing an enokitake mushroom extract of the present embodiment includes:

immersing an enokitake mushroom fruiting body in alcohol, subsequently separating the fruiting body from the alcohol; and

immersing the separated enokitake mushroom fruiting body in water at 80° C. or higher, subsequently obtaining a supernatant as an extract.

Further, the production method of the present embodiment, as necessary, may include immersing the enokitake mushroom fruiting body in an acidic solution, before immersion in alcohol, and subsequently separating the fruiting body from the acidic solution.

In the present embodiment, a fruiting body consisting of a stem part and a pileus part of an enokitake mushroom (Flammulina velutipes (Curt.: Fr.) Sing) is used as the material.

Enokitake mushroom may be either naturally grown or artificially cultivated, and the origin thereof and the like are also irrelevant.

In addition, the enokitake mushroom fruiting body as referred in the present embodiment encompasses a raw fruiting body of enokitake mushroom (Flammulina velutipes (Curt.: Fr.) Sing), a dried product of the enokitake mushroom fruiting body, and a treated product that has been subjected to a treatment of removing components other than protein from the enokitake mushroom fruiting body.

The enokitake mushroom fruiting body can be used in the form of powder, in a dry state achieved, for example, by freeze-drying or a raw state as it is.

Alternatively, the treated product that has been subjected to the treatment of removing components other than proteins, such as polysaccharides, from the above enokitake mushroom fruiting body may also be used.

It has been conventionally known that the enokitake mushroom, a kind of fungi, contains hydrophobin. Since the enokitake mushroom is a very safe material, a very safe hydrophobin extract is obtained by extracting hydrophobin from the enokitake mushroom.

### [Acid Treatment Step]

In the present embodiment, an acid treatment step, in which the enokitake mushroom fruiting body is immersed in an acidic solution before immersion in alcohol, and subsequently separated from the acidic solution, may be carried out.

The acid treatment step is not necessarily required to carry out.

Examples of the acidic solution used in the acid treatment step include aqueous solutions of acid such as acetic acid and citric acid.

Particularly, it is preferable to use an aqueous solution of acetic acid from the viewpoint of safety.

The pH of the acidic solution is preferably adjusted to about pH 1.0 to 3.0, particularly preferably about pH 1.0 to 2.0.

When the pH is within the above range, hydrophobin can be effectively extracted.

In the acid treatment step, the above fruiting body powder is suspended in the acidic solution, allowed to remain immersed in the acidic solution for 10 to 60 minutes, and subsequently the suspension is separated into supernatant and precipitate that is the enokitake mushroom fruiting body, by a known separation method such as centrifugation, filtration, and decantation.

When the precipitate is collected by the centrifugation, the centrifugation is preferably performed, for example, at 8,000×g to 10,000×g for about 10 to 30 minutes.

In the acid treatment step, an amount of the acidic solution in which the enokitake mushroom fruiting body is immersed is preferably, for example, about 1 ml to 2 ml per 20 mg (on an absolute dry weight basis) of the enokitake mushroom fruiting body.

In the acid treatment step of the present embodiment, the above immersion and the separation may be repeated several times. More specifically, the separated precipitate after immersion in the acidic solution is further immersed in the acidic solution to separate the precipitate, thereby obtaining an extract containing few impurities and a larger amount of hydrophobin.

### [Alcohol Treatment Step]

In the present embodiment, an alcohol treatment step, in which the enokitake mushroom fruiting body after subjected to the acid treatment step is immersed in alcohol and subsequently separated from the alcohol, is carried out.

The alcohol used in the present embodiment is not particularly limited, and examples include ethyl alcohol, methyl alcohol, 1-propanol, and the like.

Of these, use of ethyl alcohol is preferable from the viewpoint of safety.

The enokitake mushroom fruiting body (precipitate) separated in the acid treatment step is suspended in the above alcohol and allowed to remain immersed in the alcohol. The temperature of the alcohol at this time is preferably low at about −80° C. to −10° C. from the viewpoint of suppressing dissolution of the protein in the alcohol.

In the alcohol treatment step, the amount of the alcohol for immersing the enokitake mushroom fruiting body is preferably, for example, about 1 ml to 2 ml per 20 mg (on an absolute dry weight basis) of the enokitake mushroom fruiting body.

The precipitate is suspended and then immersed in the alcohol solution for 10 to 60 minutes, and subsequently the suspension is separated into supernatant and precipitate that is the enokitake mushroom fruiting body, by a known separation method such as centrifugation, filtration, or decantation.

When the precipitate is collected by the centrifugation, the centrifugation is preferably performed, for example, at 8,000×g to 10,000×g for about 10 to 30 minutes.

In the alcohol treatment step of the present embodiment, the immersion and the separation of precipitate may be repeated several times. More specifically, the separated precipitate, after immersed in alcohol, is further suspended and immersed in the alcohol to separate the precipitate, thereby obtaining an extract containing few impurities and a larger amount of hydrophobin.

In the present embodiment, the precipitate may be allowed to stand in an evacuable space such as a draft chamber for a period of about 60 to 240 minutes to volatilize the alcohol to remove the alcohol contained in the enokitake mushroom fruiting body obtained in the form of precipitate after the above alcohol treatment step.

### [Extraction Step]

Next, an extraction step, in which the enokitake mushroom fruiting body (precipitate) separated in the alcohol treatment step is immersed in water at 80° C. or higher to obtain the extract, is carried out.

The precipitate is immersed in water at 80° C. or higher, preferably boiling water at 100° C., for 10 to 60 minutes, preferably 20 to 40 minutes.

After cooling the above water to below 80° C., preferably about 30° C. to 40° C., centrifugation or the like is further conducted at 8,000×g to 10,000×g for 10 to 30 minutes to obtain a supernatant as the enokitake mushroom extract.

The enokitake mushroom extract obtained by the production method of the present embodiment contains hydrophobin.

The hydrophobin is low molecular proteins composed of about a few hundred amino acids containing cysteine residues, which form a disulfide crosslinkage, and structurally divided into SDS-soluble class II and SDS-insoluble class I.

In addition, the “hydrophobin” as referred in the present embodiment indicates the above hydrophobin and fusion proteins, in which other polypeptides, polysaccharides, or the like are fused to the hydrophobin.

The hydrophobin contained in the enokitake mushroom extract obtained in the present embodiment is considered to belong to the SDS-soluble class II.

The hydrophobin belonging to the above class II shows a binding ability to bind to inorganic particles, polysaccharides, other proteins, and the like, and emulsification activity, and is hence considered to be used for various products such as food additives, cosmetic additives, chemical products, adhesives, and paints.

Since the enokitake mushroom extract obtained by the production method of the present embodiment can be obtained without using harmful extraction chemicals, it has an advantage of being very safe.

There is another advantage that when the production method of the present embodiment is used, the enokitake mushroom extract is obtained in a relatively large amount, with good production efficiency at a low production cost.

The enokitake mushroom extract of the present embodiment can be used as a food additive.

The enokitake mushroom extract can be produced as a food additive, for example, in the form of dried powder, or the like, or in the form of liquid, or the like, by being dissolved in a solvent.

Further, the extract may be mixed as necessary with other components such as proteins and polysaccharides.

The food additive of the present embodiment shows a binding ability to bind to polysaccharides, other proteins, or the like, and the emulsification activity, as described above, and hence can be added to various food products as a food additive for imparting thickening property and emulsifying property.

Also, the enokitake mushroom extract of the present embodiment adheres to the surface of inorganic particles such as titanium oxide, zinc oxide, and iron oxide and can change the surface properties of the inorganic particles.

The method for adhering the enokitake mushroom extract to the surface of inorganic particles is not particularly limited, and inorganic particles, for example, are mixed with a solution containing the enokitake mushroom extract to allow the enokitake mushroom extract to adhere to the surface of the inorganic particles.

The inorganic particles to which the enokitake mushroom extract is adhered have enhanced adhesiveness to the skin and the surface of various members of metal, and other materials due to the enokitake mushroom extract, and thus can be used as a raw material for cosmetic ingredients, paints, and the like.

Further, the enokitake mushroom extract of the present embodiment can improve the surface active effect of surfactants, and the like.

Thus, when the present extract is used as a raw material for, for example, detergents, shampoos, and body soaps, the detergency can be enhanced.

According to the present invention, the very safe enokitake mushroom extract containing a relatively large amount of hydrophobin can be efficiently obtained.

More specifically, since the method for producing an enokitake mushroom extract according to the present invention includes: immersing an enokitake mushroom fruiting body in alcohol, subsequently separating the fruiting body from the alcohol; and immersing the separated enokitake mushroom fruiting body in water at 80° C. or higher, subsequently obtaining a supernatant as an extract, the extract containing a relatively large amount of hydrophobin can be efficiently obtained without using harmful chemicals. Moreover, since the method uses the very safe enokitake mushroom fruiting body as a material and obviates the use of harmful chemicals, a very safe extract can be obtained.

As the method includes immersing the enokitake mushroom fruiting body in an acidic solution and subsequently separating the fruiting body from the acidic solution, an extract containing a larger amount of hydrophobin can be obtained.

When the acidic solution has a pH within the above range, an extract containing a larger amount of hydrophobin can be obtained.

When the acidic solution is an acetic acid solution, it is preferable since it is a very safe acid.

According to the present invention, a very safe enokitake mushroom extract containing a relatively large amount of hydrophobin can be obtained.

Further, according to the present invention, a very safe food additive containing the extract containing hydrophobin obtained using a very safe enokitake mushroom as the raw material while not using harmful chemicals can be obtained.

Additionally, the method for producing an enokitake mushroom extract, the enokitake mushroom extract and the food additive of the present embodiment are as described above; however, it should be considered that the embodiments disclosed herein are examples in all aspects and not limited thereto. It is intended that the scope of the present invention is defined by the claims, not by the above description, and all changes made within the meanings and scope equivalent to the claims are to be within the scope of the present invention.

### EXAMPLES

Hereinafter, the present invention is described in further detail with reference to Examples, but the present invention is not limited in any way by the Examples.

### Yield of the Extract

### Example 1

A solid component was prepared as a test sample by suspending powder of the enokitake mushroom fruiting body in hexane and subsequently filtering the suspension, which was allowed to stand at 4° C. for more than 12 hours, using a filter paper (No. 1, produced by ADVANTEC MFS, Inc.).

2 g of the above test sample was suspended in 20 ml of a 10% acetic acid solution and subsequently the suspension was centrifuged (25,000×g, 4° C., 15 minutes) to obtain a precipitate. 2.5 g of the obtained precipitate was further suspended in 20 ml of a 10% acetic acid solution and subsequently the suspension was centrifuged (25,000×g, 4° C., 15 minutes) to obtain a precipitate.

Next, 2.5 g of the above precipitate was added to 20 ml of ethanol (−20° C.) and centrifugal separation (25,000×g, 15 minutes) was repeated twice for washing. The precipitate, from which ethanol was completely volatilized in a draft chamber, was immersed in water at 100° C. for 30 minutes, subsequently cooled to 40° C. and mixed to obtain the centrifuged (25,000×g, 4° C., 15 minutes) supernatant as an enokitake mushroom extract.

### Example 2

An enokitake mushroom extract obtained by treating the same test sample as in Example 1 in the same manner as in Example 1, except that the sample was not suspended in an acetic acid solution, was used as Example 2.

### Comparative Example 1

An enokitake mushroom extract solution to be used as Comparative Example 1 was obtained in the same manner as in Example 1, except that the 10% acetic acid solution used in Example 1 was replaced with a solution in which trichloroacetic acid was dissolved to be 5% (% by mass) in a washing buffer solution (0.1 M Tris-HCl, pH 8.0, 10 mM MgSO₄, an ultrapure water solution of 1 mM PMSF (phenylmethylsulfonyl fluoride)) and the precipitate was immersed in an aqueous solution of sodium dodecyl sulfate (2% by mass) at 100° C. in place of water at 100° C.

### Comparative Example 2

An enokitake mushroom extract solution to be used as Comparative Example 2 was obtained in the same manner as in Example 1, except that the treatment by ethanol as in Example 1 was not carried out.

### Comparative Example 3

An enokitake mushroom extract solution to be used as Comparative Example 3 was obtained in the same manner as in Example 1, except that the treatment by water at 100° C. as in Example 1 was not carried out.

### Comparative Example 4

2 g of the same test sample as in Example 1 was immersed in water at 100° C. for 30 minutes, and the centrifuged (25,000×g, 4° C., 15 minutes) supernatant was obtained as the enokitake mushroom extract of Comparative Example 4.

The protein concentrations in the enokitake mushroom extract solutions of Examples 1, 2 and Comparative Examples 1 to 4 were measured as follows.

### [Measurement Method for Protein Content]

The protein contents in the present Examples were measured in accordance with the Lowry assay.

The Lowry assay kit used was RC DC Protein assay (produced by Bio-Rad Laboratories, Inc.).

For the reagent used was A′ reagent, which is a mixture of 250 μl of A reagent and 5 μl of S reagent, which are the DC protein assay reagents enclosed in the above kit.

The A′ reagent was mixed with 50 μl of each of the enokitake mushroom extract solutions of Example 1 to Comparative Example 4 for 1 minute using a vortex mixer, and subsequently 2.0 ml of B reagent, the above DC protein assay reagent, was further added thereto and mixed for 1 minute using the vortex mixer.

The test samples mixed with these reagents were measured for the absorbance at 750 nm using a spectrophotometer (U-2001 Spectrophotometer, produced by Hitachi, Ltd.). Ultrapure water (Mill-Q) was used as a blank.

Calibration curves were constructed using a BSA (bovine serum albumin) solution as the standard solution to calculate the protein concentrations in Example 1 to Comparative Example 4 therefrom.

The results were as follows.

Example 1: 0.86% by mass

Example 2: 0.30% by mass

Comparative Example 1: 1.50% by mass

Comparative Example 2: 0.018% by mass

Comparative Example 3: 0.0079% by mass

Comparative Example 4: 0.046% by mass

Relatively large amounts of proteins were extracted from Examples 1 and 2 without using SDS. In particular, in Example 1, protein was extracted in an amount equivalent to that in Comparative Example 1.

Further, in Comparative Examples 2 to 4, protein was extracted only in amounts smaller than those in Examples 1 and 2.

### <<Emulsification Activity Test 1>>

The enokitake mushroom extract of Example 1 was tested for the emulsification activity.

The emulsification activity was evaluated by the method using the emulsification index (E₂₄).

First, the enokitake mushroom extract obtained in Example 1 was diluted with ultrapure water to give various concentrations of 1.00 mg/ml, 0.63 mg/ml, 0.42 mg/ml, 0.31 mg/ml, 0.21 mg/ml, 0.16 mg/ml and 0.13 mg/ml.

1 ml of the enokitake mushroom extract of each concentration and 1 ml of kerosene were placed in a Teflon sealed screw-top test tube and stirred for 60 seconds using a vortex mixer. Then, the mixture was allowed to stand at 4° C., 30° C. and 37° C., for 24 hours, respectively, and the overall height to the liquid surface and the height of emulsion were measured to calculate the emulsion height relative to the overall height as the E₂₄ (emulsification activity index).

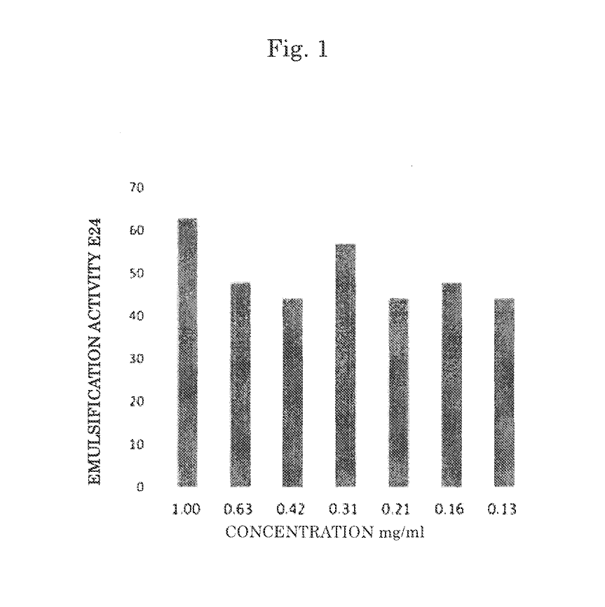

The results are shown in FIG. 1.

As shown in FIG. 1, the enokitake mushroom extract of Example 1 had an E₂₄ of exceeding 40% at all concentrations, suggesting high emulsification activities.

### <<Emulsification Activity Test 2>>

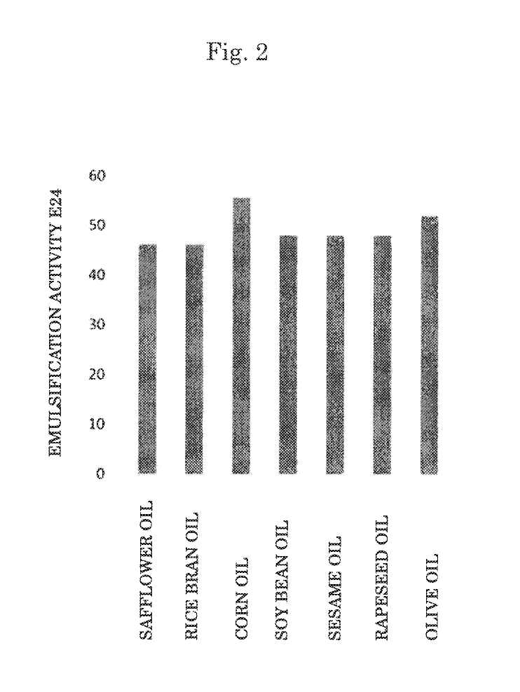

In place of kerosene used in the above Emulsification activity Test 1, 1 ml of each of safflower oil, rice bran oil, corn oil, soy bean oil, sesame oil, rapeseed oil and olive oil and 1 ml of the enokitake mushroom extract (a concentration of 0.31 mg/ml) obtained in Example 1 were mixed and measured for the E₂₄ described above, with the results shown in FIG. 2.

As shown in FIG. 2, the enokitake mushroom extract of Example 1 has the emulsification activity on all the oils.

It is to be noted that the enokitake mushroom extract has high emulsification activity even on olive oil, which is hardly emulsified by the conventional bio-based emulsifiers.

### <<Emulsification Activity Test 3>>

In place of kerosene of the above Emulsification activity Test 1, 1 ml of olive oil and 1 ml of a diluted solution in which the enokitake mushroom extract obtained in Example 1 was diluted to have a protein concentration of 175 μg/ml were mixed and measured for the E₂₄ described above.

The protein concentration in the enokitake mushroom extract was measured in the same manner as in the measurement method for protein content described above.

In addition, 20 mM KH₂PO₄ (pH 7) containing 0.3 M NaCl used for dilution was used in place of the blank ultrapure water (Mill-Q) used in the above Lowry assay.

For comparisons, mixtures of each of various commercial surfactants in place of the enokitake mushroom extract and 1 ml of olive oil were measured for the above E₂₄ in the same manner.

The commercial surfactants used are the following 3 products.

### [Surfactants]

Surfactant 1: Poem DL-100, produced by Riken Vitamin Co., Ltd., 100 μg/ml (diglycerin monolaurate)

Surfactant 2: Poem DP-100, produced by Riken Vitamin Co., Ltd., 100 μg/ml (glycerin fatty acid ester)

Surfactant 3: Poem M-300, produced by Riken Vitamin Co., Ltd., 100 μg/ml (glycerin fatty acid ester)

The results are as follows.

Enokitake mushroom extract: E₂₄ 62.1% Surfactant 1: E₂₄ 0.00%

Surfactant 2: E₂₄ 0.00%

Surfactant 3: E₂₄ 0.00%

As evident above, the enokitake mushroom extract has high emulsification activity even on olive oil, which is hardly emulsified by commercial surfactants.

### <<Test on Reactivity (Binding Ability) to Polysaccharides>>

The reactivity (binding ability) of the enokitake mushroom extract of Example 1 to polysaccharides was tested.

Mixtures, in which 0.1 ml of the enokitake mushroom extract (0.16 mg/ml) of Example 1 and 1.0 ml of each of hydroxypropyl cellulose (HPC), pectin and waxy cornstarch (each 0.5% by mass) as the polysaccharide were mixed, the enokitake mushroom extract alone, and each of the polysaccharides alone were measured for the peak molecular weight at UV 280 using a GPC apparatus (HLC-8320GCP (equipped with a built-in RI detector), produced by Tosoh Corporation).

The column used was TSK_{gel}GMPWₓₗ (7.8 mm I.D.×30 cm×2 columns), and the buffer solutions used were 0.15 mM NaCl and Tris-HCl. The measurement was carried out at a flow rate of 1.0 ml/min.

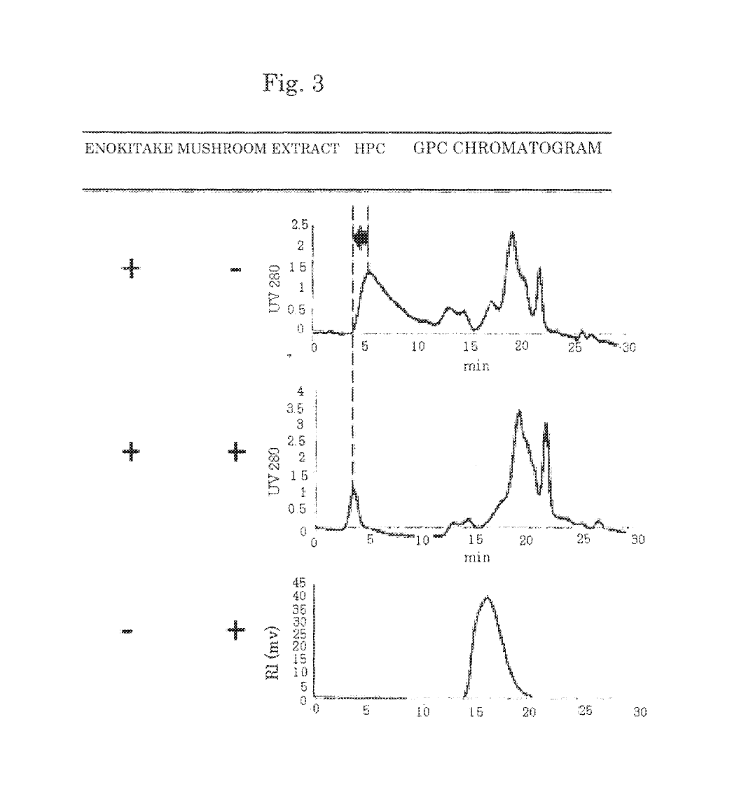

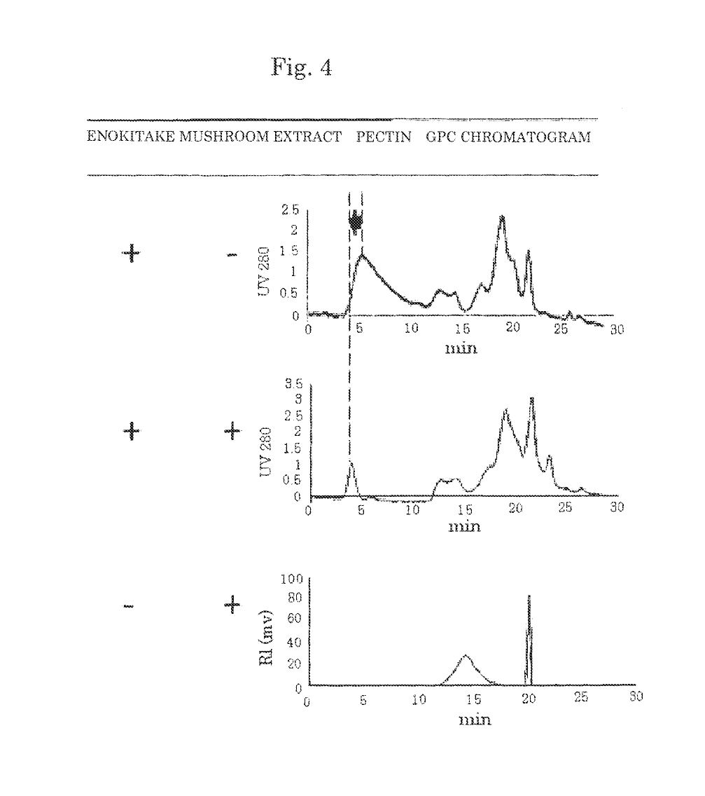

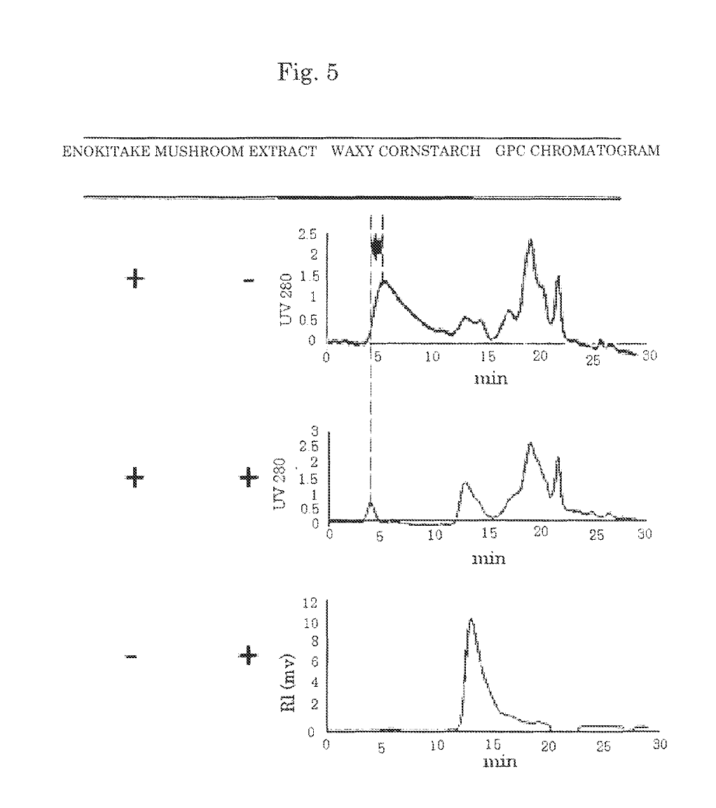

FIG. 3 to FIG. 5 show GPC chromatograms showing the measurement results.

As shown in FIG. 3 to FIG. 5, in all GPC chromatograms, the peaks appear at different positions (times) between the enokitake mushroom extract alone or each of the polysaccharides alone and the mixture of the enokitake mushroom extract with each of the polysaccharides.

This verifies that the enokitake mushroom extract has the binding ability to each polysaccharide and the conjugate of the polysaccharide and the enokitake mushroom extract was formed in each of the mixtures.

Further, the above Emulsification activity Tests 1 to 3 and Test on reactivity (binding ability) to polysaccharides reveal that the proteins obtained in Examples are proteins containing the hydrophobin class II showing the emulsification activity and the binding ability to the polysaccharides.

### <<Test on Binding Ability to Proteins and Inorganic Particles>>

The binding ability of the enokitake mushroom extract of Example 1 to proteins and inorganic particles was tested by the following method.

The samples of proteins and inorganic particles used to be tested for the binding ability with the enokitake mushroom extract are as follows.

### [Test Samples]

Keratin: wool, produced by Tokyo Chemical Industry Co., Ltd.

Collagen: Type I, produced by Sigma-Aldrich Co. LLC.

Titanium oxide: product exclusively used for manufacture, produced by Wako Pure Chemical Industries, Ltd.

Zinc oxide: produced by Wako Pure Chemical Industries, Ltd.

Ferric oxide: produced by Wako Pure Chemical Industries, Ltd.

First, the protein concentration in the enokitake mushroom extract of Example 1 was measured in the same manner as in the Lowry assay described above and found to be 205.2 μg/ml. The enokitake mushroom extract was further diluted to 5 serial concentrations of 2-, 3-, 4-, and 5-fold dilutions.

Additionally, 20 mM KH₂PO₄ (pH 7) containing 0.3 M NaCl used for dilution was used in place of the blank ultrapure water (Mill-Q) used in the above Lowry assay.

Next, mixtures, in which 1 ml of the enokitake mushroom extract of Example 1 and 0.05 g of each of the test samples containing the above proteins and inorganic particles for test samples were mixed, were shaken for 3 hours using a shaker (NR-2, produced by TAITEC CORPORATION) in a thermostatic chamber at 30° C. Subsequently, the mixture was centrifuged using a centrifugal separator (CF16RX, produced by Hitachi Koki Co., Ltd.) at 10,000×g for 10 minutes to collect the supernatant.

The collected supernatant was measured for the protein concentration (B: unit μg/ml) by the Lowry assay described above.

Additionally, 20 mM KH₂PO₄ (pH 7) containing 0.3 M NaCl used for dilution was used in place of the blank ultrapure water (Mill-Q) used in the above Lowry assay.

Further, as a control, the supernatant of a mixture, in which 1 ml of ion exchange water in place of the enokitake mushroom extract, and 0.05 g of each of the test samples were mixed, was collected in the same manner as above and the protein concentration (C: unit μg/ml) was measured in the same manner.

Furthermore, the supernatant of 1 ml of the enokitake mushroom extract of Example 1 was collected in the same manner as above and the protein concentration (d: unit μg/ml) was measured in the same manner. The difference (D) between the protein concentration (d) in the supernatant of the enokitake mushroom extract and the protein concentration (A) in the enokitake mushroom extract was calculated.

Each measured value and calculated value were applied to the following calculation formula to determine an adhesion rate.

Adhesion rate (%)=[{A−(C+D)}−B]÷{A−(C+D)}

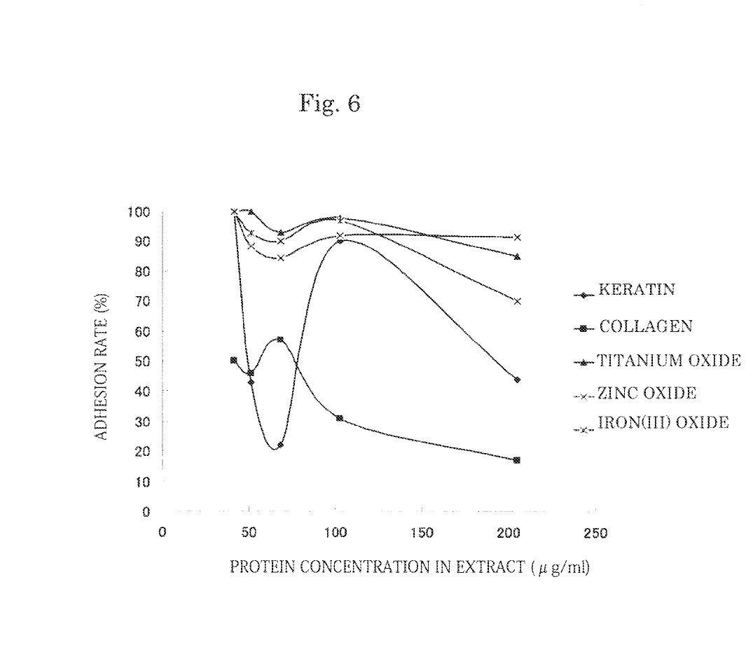

The relation of the above adhesion rate and the protein concentrations in the enokitake mushroom extract mixed with each test sample is shown by the graph in FIG. 6.

As shown in FIG. 6, the protein in the enokitake mushroom extract had high adhesion rates to any of the test samples. Particularly, high adhesion rates were stably shown to titanium oxide, zinc oxide and iron oxide in all concentration ranges.

More specifically, it is evident that the enokitake mushroom extract has high binding ability to proteins and inorganic particles.

### <<Test on Surface Activity Improvement>>

6.5 ml of the enokitake mushroom extract (a protein concentration of 100 μg/ml) of Example 1 and 6.5 ml of a commercial shampoo solution (trade name “Super MiLD,” produced by Shiseido Company, Limited) were placed in a graduated cylinder, manually stirred for 1 minute under the condition of 25° C. and the height of bubbles was measured every 10 minutes.

For a comparison, a mixture of 6.5 ml of water and the above shampoo solution was measured for the height of bubbles in the same manner.

The height of bubbles was measured using a ruler from the side of the graduated cylinder.

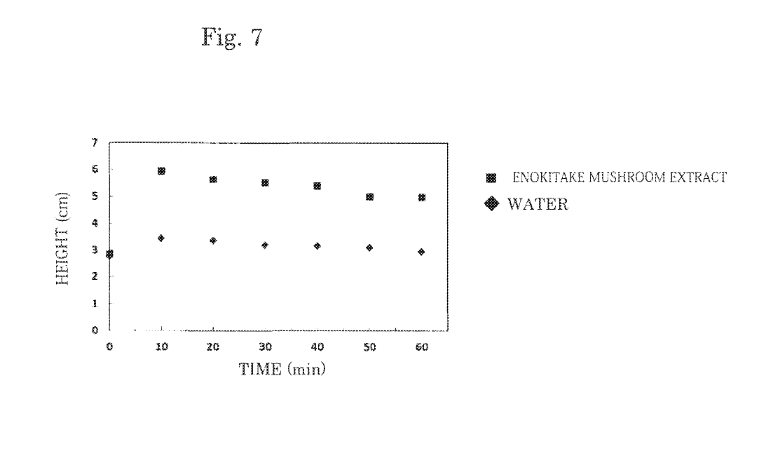

The results are shown by the graph in FIG. 7.

As shown by the graph in FIG. 7, when the shampoo solution was mixed with the enokitake mushroom extract, the height of bubbles is taller than that when the shampoo solution was mixed with water for all stirring times, based on which, it became evident that the enokitake mushroom extract improves the surface activity effect of the shampoo solution.

1. A method for producing an enokitake mushroom extract comprising:
immersing an enokitake mushroom fruiting body in alcohol, subsequently separating the fruiting body from the alcohol; and
immersing the separated enokitake mushroom fruiting body in water at 80° C. or higher, subsequently obtaining a supernatant as an extract.

2. The method for producing an enokitake mushroom extract according to claim 1, comprising immersing an enokitake mushroom fruiting body in an acidic solution, before immersion in alcohol, and subsequently separating the fruiting body from the acidic solution.

3. The method for producing an enokitake mushroom extract according to claim 2, wherein the acidic solution has a pH of 1.0 to 3.0.

4. The method for producing an enokitake mushroom extract according to claim 2, wherein the acidic solution is an acetic acid solution.

5. An enokitake mushroom extract extracted by: immersing an enokitake mushroom fruiting body in alcohol, subsequently separating the fruiting body from the alcohol; and
immersing the separated enokitake mushroom fruiting body in water at 80° C. or higher.

6. A food additive containing the enokitake mushroom extract according to claim 5.

7. The method for producing an enokitake mushroom extract according to claim 3, wherein the acidic solution is an acetic acid solution.
